(19) United States
(12) Patent Application Publication
(10) Pub. No.: US 2004/0117857 A1
(43) Pub. Date: Jun. 17, 2004

(54) System and a method for personalised, transaction-oriented, interactivity over non-interactive (one way) broadcast networks

(76) Inventors: Chatschik Bisdikian, Chappaqua, NY (US); Nathan J. Lee, New City, NY (US); Mahmoud Naghshineh, Hopewell Junction, NY (US); Giovanni Pacifici, New York, NY (US); Jurij R. Paraszczak, Pleasantville, NY (US)

Correspondence Address: David Aker, 23 Southern Road, Hartsdale, NY, 10530, US

(21) Appl. No.: 10/320,262

(22) Filed: Dec. 16, 2002

(51) Int. Cl. H04N 7/16

(52) U.S. Cl. 725/141; 725/153

(57) ABSTRACT

This invention provides a system, a method and a computer readable medium having program code thereon for using a one-way digital broadcast medium to support interactive and personalized e-commerce applications. The broadcast data may include regular programming, e.g., a TV broadcast, and other supplemental data-streams. A set-top box receiving the transmission, demultiplexes the data streams and provides any additional data streams to personal devices that request to access the data streams. Users of these devices can then complete e-commerce and other interactive services using a secondary back channel, e.g., a cellular network, to connect back to the e-commerce provider.

### FIELD OF THE INVENTION

This invention is directed to the field of electronic commerce (e-commerce). It is more particularly directed to e-commerce transactions using broadcast digital TV networks and personal devices.

### BACKGROUND OF THE INVENTION

The advent of interactive two-way television (TV) systems, be it over satellite or cable systems, was expected to bring a bonanza to personalized, impulse e-commerce and new revenue streams to TV service providers. However, the development of two-way data networks has been proven to be a very expensive feat and it lags considerably behind the deployment of advanced (digital) one-way broadcast systems. An alternative solution that was considered by the broadcast data service providers has been through usage of the wired PSTN as the return path. Today, TV viewers typically experience this when they use touch-tone telephony DTFM (dual-tone multifrequency) signaling to select and view a pay-per-view premium TV program. However, the use of a digital data return path capable of computer communications will require the use of modem banks and servers at the service provider site to handle the input from the viewers. Thus, because of the cost of the infrastructure that is needed to enabled personalized e-commerce which the TV service providers must bear, the vision has yet to materialize.

### SUMMARY OF THE INVENTION

This invention is concerned with mechanisms by that users, using their own personal devices such as notebook computers and personal digital assistants (PDAs), can perform e-commerce transaction at their leisure using information data they receive over a broadcast data channel, like the one provided via a digital TV broadcast system. It is envisioned that with the help of additional data streams incorporated within the regular transmissions of TV programming will permit TV viewers to select an item of interest viewed on a TV screen and via an interactive two-way TV plant place a related purchase order. For example, during the viewing of a sports event, a viewer may retrieve purchase information for the sports shoes, or golf club, etc., that the athlete wears or uses. It is further envisioned that multiple viewers may retrieve multiple types of related data and act upon them independently. For example, in the previous case, another viewer may be interested in sports statistics, rather than purchasing anything.

The rapid penetration of cellular telephony, and personalized long-haul wireless connectivity in general, has enabled the development of services that can target individuals and hence be inherently personalized. To realize the aforementioned vision, this invention, combines the simple, broadcast nature of broad band information to masses of people, with the capability of wide-area cellular telephony to provide personalized e-commerce and other interactive data services. This invention leverages existing technologies; namely today's one-way digital TV technology and wirelessly connected personal/devices, such as cell-phones and PDAs, without requiring TV service providers to have the extra infrastructure to handle the user inputs.

It is thus an object of this invention to allow providers of one-way broadcast digital content, best exemplified by digital TV broadcasting by cable and satellite TV operators, to provide interactive e-commerce and other data services via communications-capable personal user devices.

Another object of this invention is to allow the interactive data services to be executed asynchronously in a disconnected mode of operation, where the personal user device is only intermittently connected to a communications network.

A further object of this invention is to allow a first receiver, e.g., a viewer or a listener, of a common broadcast transmission to participate in personalized interactive data service without interfering with the actions taken by other receivers of the same broadcast transmission residing in proximity of the first receiver.

Yet another object of this invention is to provide a data stream tagging process by which a piece of information pertaining to a particular interactive data service is associated with a user interested in executing an action based on this information at a future time.

Still another object of this invention is providing articles of manufacture including computer readable code for performing the methods and operating the apparatus in accordance with the invention.

### BRIEF DESCRIPTION OF THE DRAWINGS

These and other objects, features, and advantages of the present invention will become apparent upon further consideration of the following detailed description of the invention when read in conjunction with the drawing figures, in which:

FIG. 1 shows an exemplary of a system for providing one-way broadcast TV services.

FIG. 2 shows an exemplary of a system for providing e-commerce services over a cellular phone.

FIG. 3 shows a system designed according to an exemplary embodiment of this invention comprising a digital TV downlink, a cellular telephony link as a secondary communications path and a cellular phone as the user personal device.

FIG. 4 shows a system designed according to an exemplary embodiment of this invention comprising a digital TV downlink, a cellular telephony link as a secondary communications path and a personal digital assistant (PDA) as the user personal device.

FIG. 5 shows a system designed according to an exemplary embodiment of this invention comprising a digital TV downlink, two secondary communications path alternatives (a) a cellular telephony link, and (b) a digital subscriber line (DSL); and two alternatives for user devices (a) a cellular phone and (b) a PDA.

FIG. 6 shows a system designed according to an exemplary embodiment of this invention comprising a digital TV downlink, two secondary communications path alternatives (a) a cellular telephony link, and (b) a digital subscriber line (DSL); and two alternatives for user devices (a) a cellular phone and (b) a PDA, and a content provider providing content to the digital TV provider.

FIG. 7 shows the system of FIG. 6 with the addition of a non-real time communication option.

FIG. 8 shows the multiplexing and demultilpexing of data streams transmitted over a digital video broadast distribution network for an exemplary embodiment of this invention.

FIG. 9 shows the protocol stack and architecture of a set-top box and a personal device for an exemplary embodiment of this invention.

FIG. 10 shows processing elements along the downlink and secondary communications paths for an exemplary embodiment of this invention.

FIG. 11 shows a listing of possible identifiers for the transmitted data for an exemplary embodiment of this invention.

FIG. 12 shows steps followed during the dissemination of digital content via the one-way digital video broadcast distribution network for an exemplary embodiment of this invention.

FIG. 13 shows steps followed during the interaction between a user and a e-commerce service provider over a two-way (cellular) network for an exemplary embodiment of this invention.

### DESCRIPTION OF THE INVENTION

The present invention provides a system for a service provider of digital broadcast content, e.g., a cable or satellite TV service provider, to offer personalized e-commerce and other interactive data services to its subscribers over its one-way broadcast communications network.

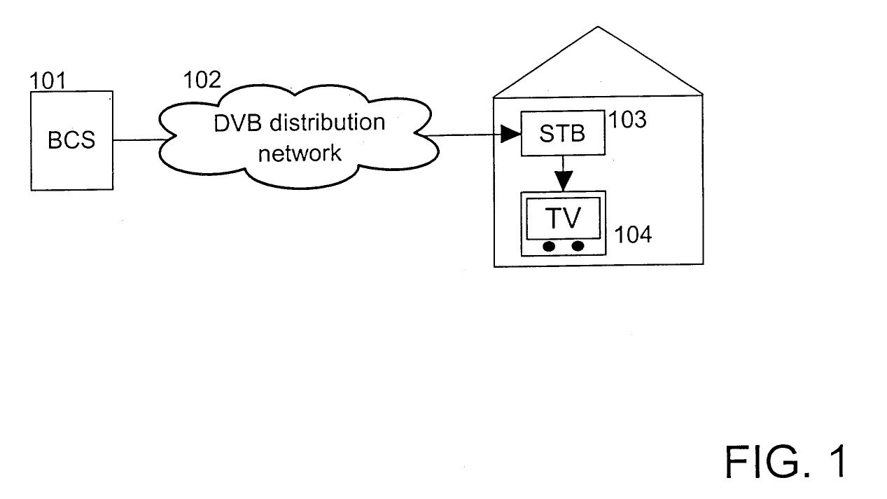

FIG. 1 shows the key elements of a typical digital network carrying TV broadcasts. It comprises a broadcast service provider (BCS) 101, e.g., a cable TV (CaTV) or a satellite TV (SaTV) operator, a digital video broadcast (DVB) distribution network 102, e.g., a digital CaTV or digital SaTV distribution network, and a digital set-top box (STB) 103, that receives the broadcast signals and transforms them into a signal that can be shown on an attached TV set 104.

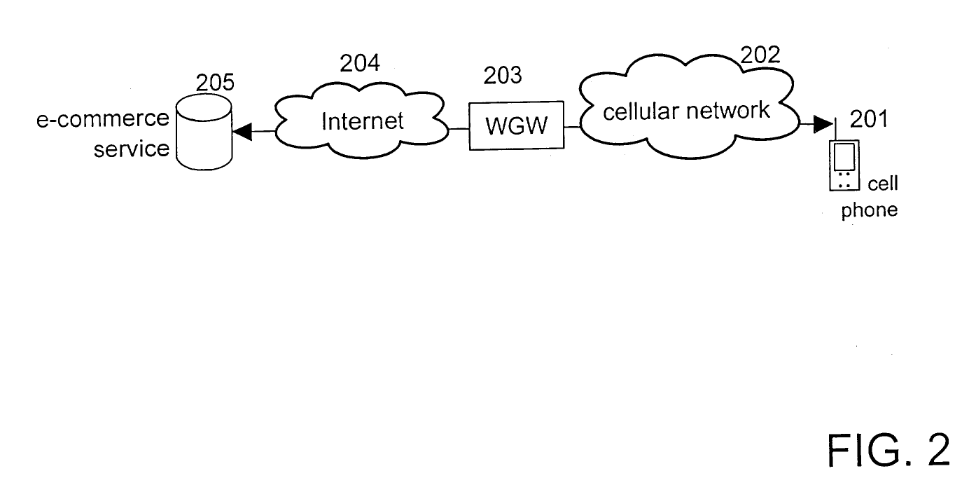

FIG. 2 shows the key elements of a typical mobile e-commerce solution. It comprises a Web-enabled cellular phone 201 that attaches to a data-capable cellular network 202. The cellular provider connects its network to the Internet 204 via a wireless gateway 203 whose job is to enable data to flow back and forth between the wirelessly connected user device and the Internet. Finally, there is the e-commerce service provider 205 from where a user can select and purchase merchandise over his/her cellular phone.

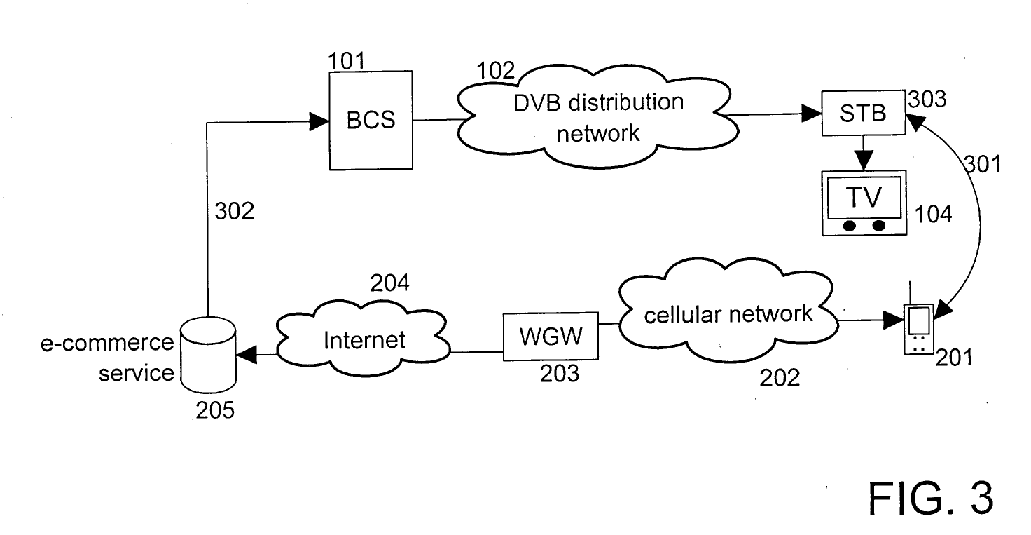

FIG. 3 shows an exemplary embodiment of this invention. In this embodiment the systems in FIGS. 1 and 2 are used and enhanced to enable the aspect of this invention of providing personalized interactive services using the one-way broadcast DVB network 102. In particular the merchandise information from the e-commerce service provider 205 is provided by a connection 302 to the broadcast services provider (BCS) 101. The BCS multiplexes, i.e., combines, information related to merchandise with its broadcast programming. For example, consider a sports apparel manufacturer sponsoring a sports event. During the broadcast of this event, the BCS could provide simultaneous broadcast transmission of purchase information for the sponsor's apparel. The purchase information may be tied to an e-commerce site from where viewers of the sports event may purchase the sponsor's apparel using their cell phones. In the embodiment of FIG. 3, the purchase information, or more generally any pertinent additional data transmitted together with the regular broadcast programming, is demultiplexed, i.e., separated, at the digital set-top box 303. The regular programming is directed to a TV set 104 and the additional information is directed 301 to a viewer's cellular phone 201. The set-top box may be connected to the cellular phone with a wire, e.g., a serial cable, or wirelessly, e.g., using a Bluetooth wireless personal area network. It is significant to note that by sending the purchase information to the cellular phone instead of displaying it on the TV, viewers of the TV broadcast are not distracted by the additional information and any related transactions.

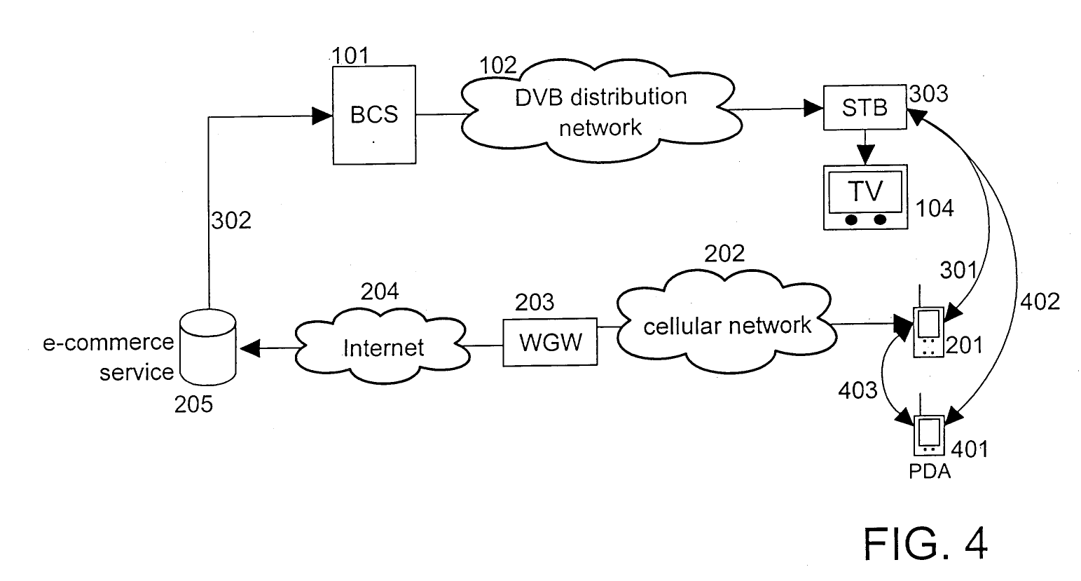

FIG. 4 shows another exemplary embodiment of this invention. It is similar to that in FIG. 3, but now the user device is a PDA 401. As before the additional information is demultiplexed at the set-top box 303. The additional information is then sent by a link 402 and displayed on the PDA using, for example, Bluetooth communications. Any additional actions taken by the user of the PDA can be transported to the e-commerce site, either directly from the PDA, if it is capable of wide-area networking, or indirectly via a nearby cellular phone to which the PDA may be connected via, for example, Bluetooth communications by a link 403. FIG. 4 shows the presence of multiple-user of the additional information. Each such user may be interested in a separate set of information. In the aforementioned sports event example, one user may be interested in statistics related to the an athlete, while another is interested in purchasing the golf-club that the athlete uses.

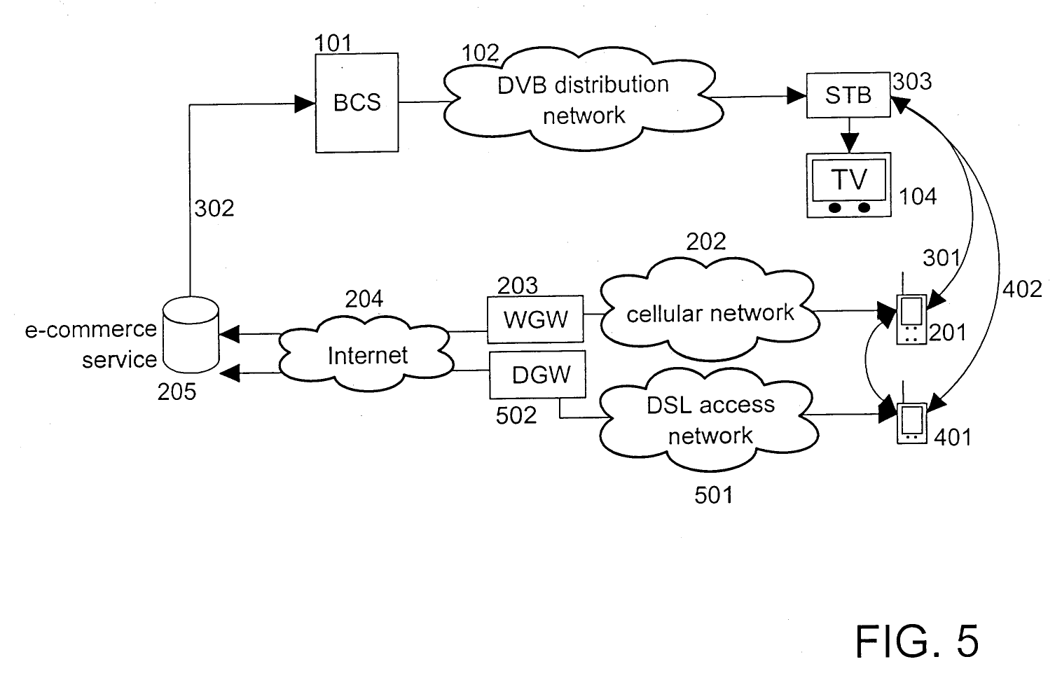

FIG. 5 shows another exemplary embodiment of this invention. It is similar to that in FIG. 4, but now the user's PDA is connected to the e-commerce service via a residential DSL line 501. The PDA may connect to the DSL termination point (modem) via wireline or wireless means, e.g., using an Ethernet, or a wireless local area network (LAN) technology. In a fashion similar to the cellular provider, the DSL provider connected to the Internet, and ultimately to the e-commerce site via a DSL gateway 502.

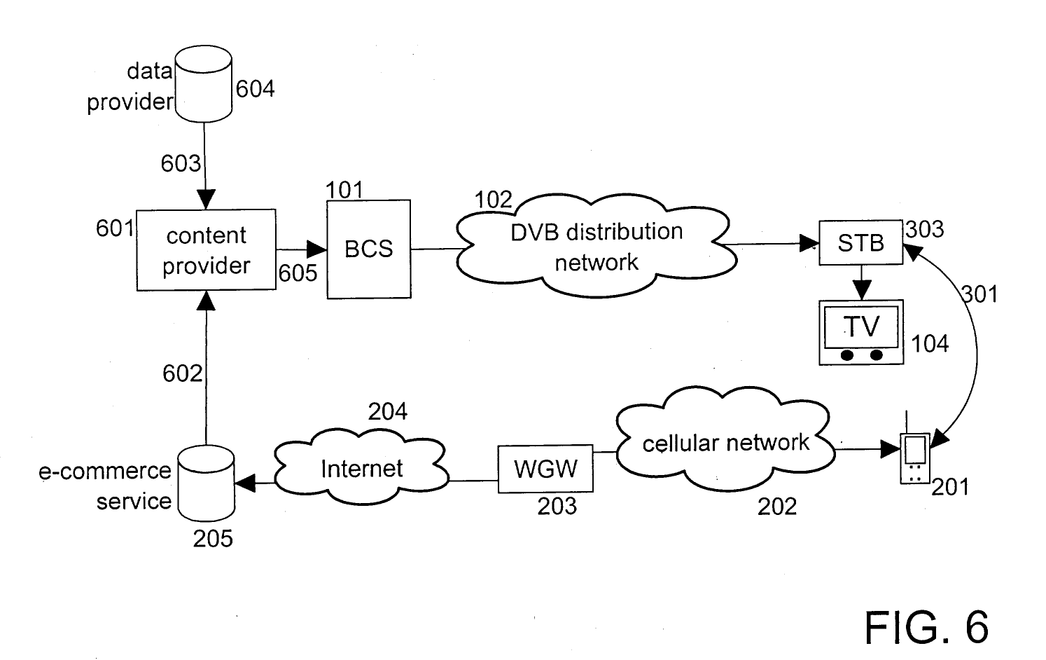

FIGS. 3, 4, and 5, show that the multiplexing of the additional information is happening at the broadcast services provider. This is not the only alternative. The multiplexing may occur elsewhere, e.g., at a content provider's site. FIG. 6 shows an exemplary embodiment of this later case. A content provider 601, multiplexes within its content information received via a connection 602 from the e-commerce service provider 205 and any additional information received via a connection 603 from other data providers 604. The combined content is then provided by a connection 605 to the broadcast services provider 101 for transmission over its DVB distribution network 102. Provided that the multiplexing occurring at the content provider's site 601 follows some certain agreed convention, the set-top box in the customer's residence 303 will still be able to demultiplex the information and transmitted it to whoever requests it as before.

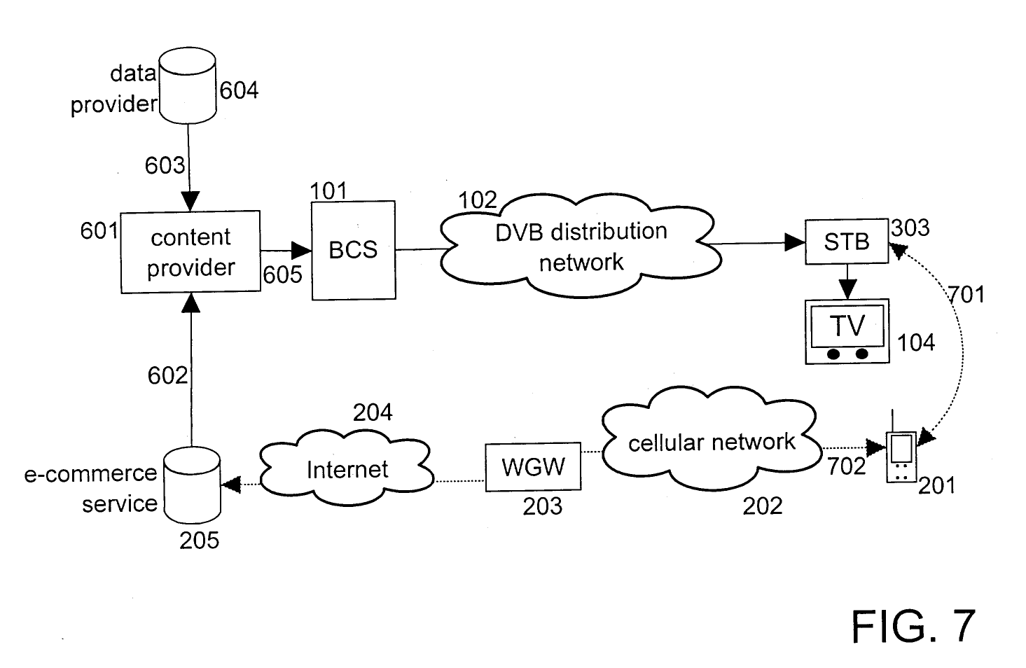

FIG. 7 shows another exemplary embodiment of this invention. It is similar to that in FIG. 6, but it demonstrates an additional aspect of this invention. In FIG. 6 it was assumed that user was taking action about, for example, purchasing sports apparel in real-time, i.e., synchronously, during the viewing of a specific clip of TV broadcasting. However, this is not necessary always the case. Taking advantage of the storage means within the set-top box 303 or the cellular phone 201, a user of the cellular phone may interact with the set-top box 701 to retrieve pertinent purchase information or with the e-commerce service provider 702 to submit a purchase request at a later time, i.e., asynchronously. Thus, there is no necessity for the user to be present during the broadcast of the TV program to engage in the related e-commerce transaction. Instead the user may review at a latter time what purchase options, for example, were available during the broadcast of the sports event. Furthermore, there is no need for the user's personal device to be connected to the set-top box 303 and the e-commerce service provider 205 at the same time. Connectivity to the set-top box and the e-commerce service provider can be staggered in time. During a first time interval the user's personal device may connect to the set-top box and retrieve the purchase options and store them locally in the device. At a second later time interval, the user may connect to the e-commerce service provider and complete the transaction, using the information stored in the personal device during the first time interval. In other words, the entire interactive transaction, from the transmission of the broadcast program to the set-top box, to the personal user device, and finally to the e-commerce service provider can be experienced asynchronously in a staggered, disconnected and non-real-time fashion. In FIG. 7, this is shown via the dashed-lines 701 and 702.

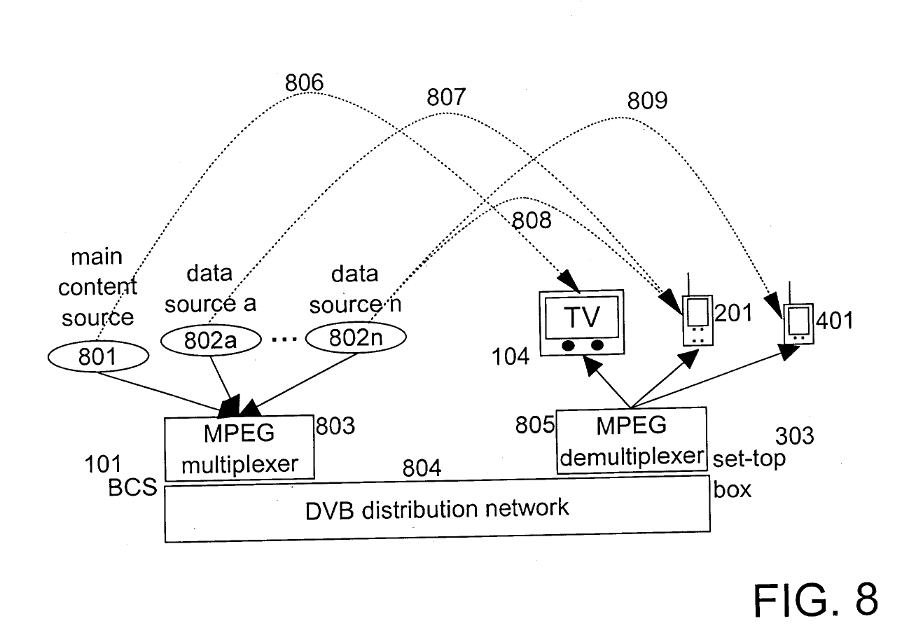

Using the exemplary embodiment in FIG. 3 as a basis, FIG. 8 focuses on the broadcast downlink and it shows the multiplexing and demultiplexing operations that take place. In FIG. 8, it is assumed that the industry standard MPEG (motion pictures expert group) is used for the digital encoding and transport of the video broadcast over the DVB distribution network 804. The MPEG standard allows for the multiplexing and transport of both asynchronous data and synchronous video information. At the broadcast services provider site, the regular broadcast content, e.g., the sports event, is multiplexed with information from related data sources 802. The data sources may contain independent or dependent information. For example the information provided by data source 802n could simply represent a table of contents for what the rest of the data sources 802 contain. This information can then be used by any user device (201, 401) on the other side of the distribution network to navigate through the information provided by the remaining data sources. Based on the life expectancy of the additional information, the data sources may produce new sets of data continuously, or the data may be renewed only periodically and transmitted by the broadcast service provider cyclically and repeatedly every so often.

Upon transport over the distribution network 804, the MPEG transmission is captured by a set-top box in a subscriber's residence. The set-top box demultiplexes the MPEG transmission, recovers the regular broadcast content and provides it to a TV set 104 for display, which is signified by the dashed line 806. The set-top box also retrieves the information from the various data sources. This information could be stored at the set-top box for a period of time to be accessed by a user via a personal user device. FIG. 8 also shows that two users using devices 201 and 401 access the additional information. The data source 802n may represent an exemplary data source containing a contents listing for the rest of the data sources, and it be accessed by both devices, as represented by paths 808 and 809. Furthermore, if the user of device 201 has found interesting information on data source 802a, the user may decide to access it as well, as represented by path 807. FIG. 8 further shows that the end-point of the data transmitted by the broadcast content service 101 is not always one and the same device. While most of the broadcast is directed, and terminated, at the TV set 104, i.e., transmission as represented by path 806, parts of the broadcast data may end-up at a personal device 201 or 401, i.e., as represented by transmissions paths 808, 807, and 809. The broadcast content service 101 multiplexes the various traffic streams for broadcast, and the set-top box 303 demultiplexes them and directs them to a fixed destination, e.g., the TV 104 for the main portion of the broadcast content, or whichever other device has requested the additional traffic streams.

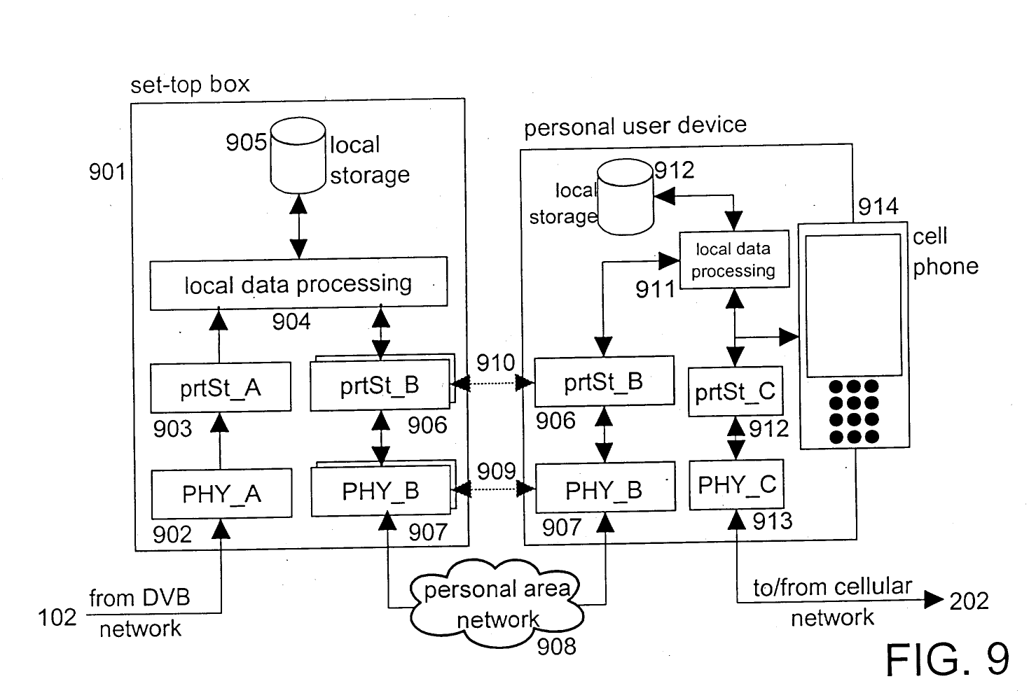

FIG. 9 shows a system configuration of a set-top box 901 and a personal user device, e.g., a cellular phone 914 and the related communication protocol stacks for an exemplary embodiment of this invention. The set-top box, typically residing in the residence of a cable or satellite digital TV subscriber, receives a broadcast transmission from the digital video broadcast network 102. The set-top box contains a radio receiver 901 matching the transmission characteristics of the DVB transmission. In FIG. 9, this is denoted by the designation PHY_A, where PHY stands for the physical layer protocol used by the DVB transmitter (located in the BCS 101 in FIG. 3) and the receiver in the set-top box. The prtSt_A 903 represents the data semantics and syntax protocols used to formulate legitimate data packets for transmission from the transmitter (again located in the BCS 101 in FIG. 3) and the receiver in the set-top box. Following the receipt of the data transmitted via the DVB network, the set-top box process the received data 904 and directs the processed data to their destination device at an appropriate time. FIG. 9 shows the case where the set-top box also contains a local storage where data can be stored for future retrieval by users. In the absence of the local storage, users can retrieve, for example, purchase information for merchandise shown on the TV screen only during the transmission of these data from the BCS 101 in FIG. 3. The presence of the local storage in the set-top box has the advantage of relaxing this restriction and thus increases the value of the offered service.

The destination device may be one or more of several devices connected to the set-top box with different means. For example, it could be an analog or a digital TV set connected to the set-top box via a coaxial cable or an IEEE 1394 cable, respectively. In addition it could be one or more personal user devices connected to the set-top box via a personal area network 908, e.g., using a Bluetooth wireless technology. FIG. 9 shows one example of a destination device which is pertinent to this invention, namely a cellular phone 914. As in the case of any data communication between two data computing devices, a suite of communication protocols is executed within the cellular phone. These protocols match corresponding ones executed within the set-top box. These protocols are shown as prtSt_B 906 and PHY_B 907. Examples of these protocols could be the Bluetooth protocol stack and the TCP/IP suite of Internet protocols. The communication between the matching communication layers in the set-top box 901 and the cellular phone is shown via the dashed links 909 and 910 which together define the communication protocols used by the personal area network 908.

Following the receipt of the data transmitted over the personal area network 908, the cellular phone 914 process the received data 904 and directs the processed data to their destination at an appropriate time. FIG. 9 shows the case where the cellular phone also contains a local storage where data can be stored for future retrieval by users. In the absence of the local storage, users must make their decisions, such as for example, purchase decision, “immediately after” the receipt of any related information via the set-top box; depending on the system design. “Immediately after” may even mean the time interval from receipt of information, until the personal user device is powered off following the receipt of, for example, the purchase information. The presence of the local storage in the cellular phone relaxes this restriction and increases the value of the offered service.

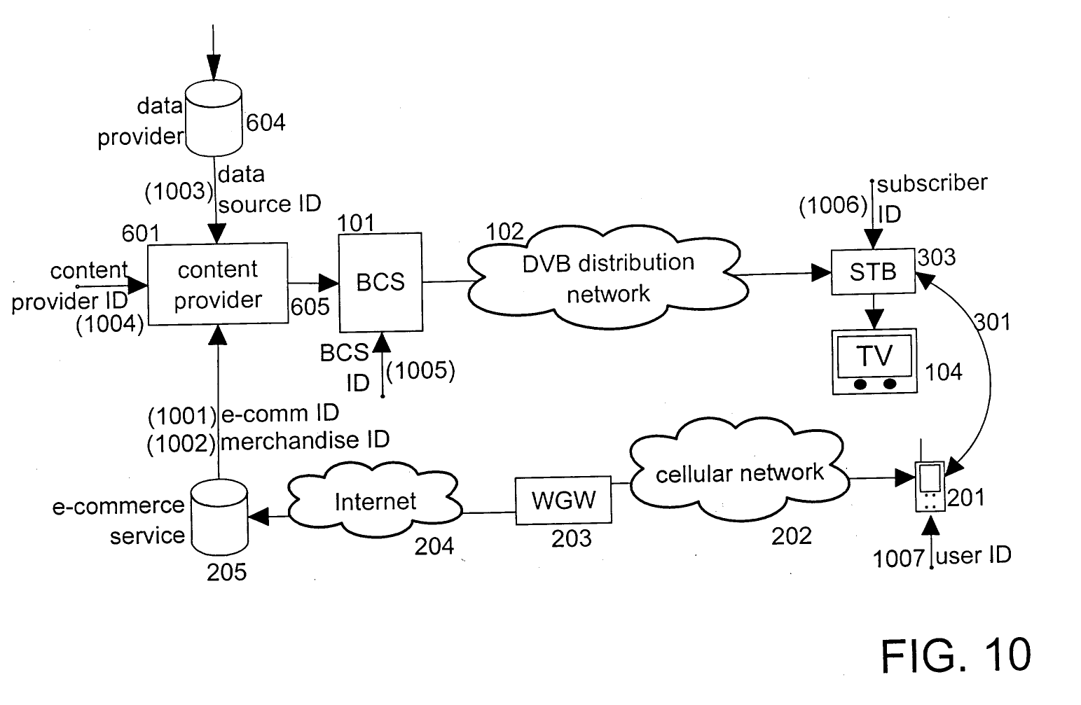

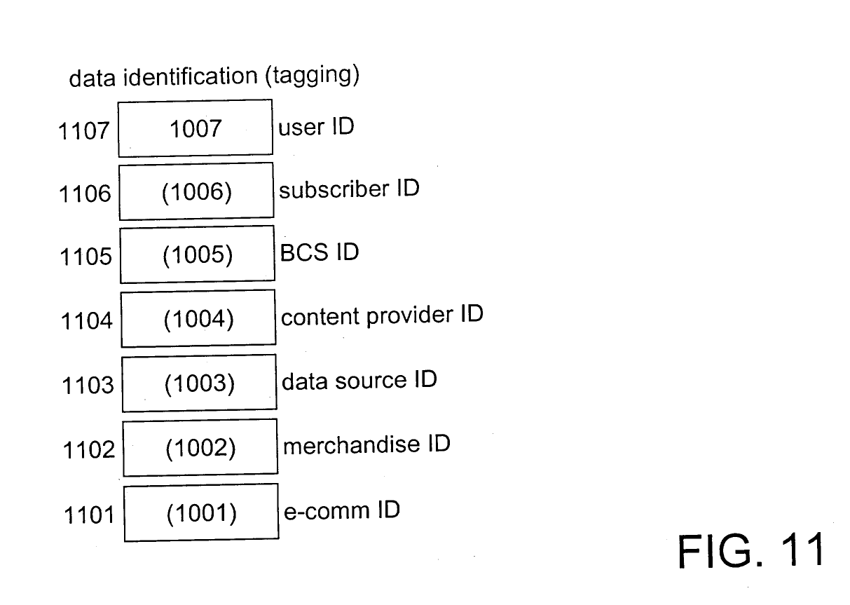

Using the exemplary embodiment in FIG. 6 as a basis, FIG. 10 shows some examples of processing points along the loop composed of the content provider, the merchandise provider, the broadcast provider, and the user. In particular, FIG. 10 shows an example of the data processing performed with regard to identifying the entity that process the data. For example, a content provider 601 collects content from various sources (its own or from third parties). Examples of third party data providers are shown in FIG. 10 as an e-commerce service 205, e.g., an on-line apparel shop, and a data provider 604, e.g., a sports statistics provider. To identify their content, the data providers tag their offerings, e.g., an e-commerce provider ID 1001 and an merchandise ID 1002 identify a specific offering from the e-commerce service 205. Similarly, the data source 604 tags its offerings with a data source ID 1003. The content provider 601 tags its cumulative offering prior to sending them via connection 605 to the broadcast content service 101 with a content provider ID 1004. Upon receipt of the broadcast over the DVB distribution network 102, the set-top box tags the data with a subscriber ID 1006. Finally, a user using a personal user device, i.e., the cellular phone 201, tags, for example, the purchase selection(s) with its own user ID 1007. The exemplary processing points are summarized in FIG. 11 as well, in blocks 1101 through 1107, for ease of reference. The numbers in parentheses, e.g., (1001) represent exemplary tagging processes that occur automatically, without requiring human intervention, while the numbers with no parentheses, e.g., 1007, represent exemplary tagging processing that may require that a human supplies input data.

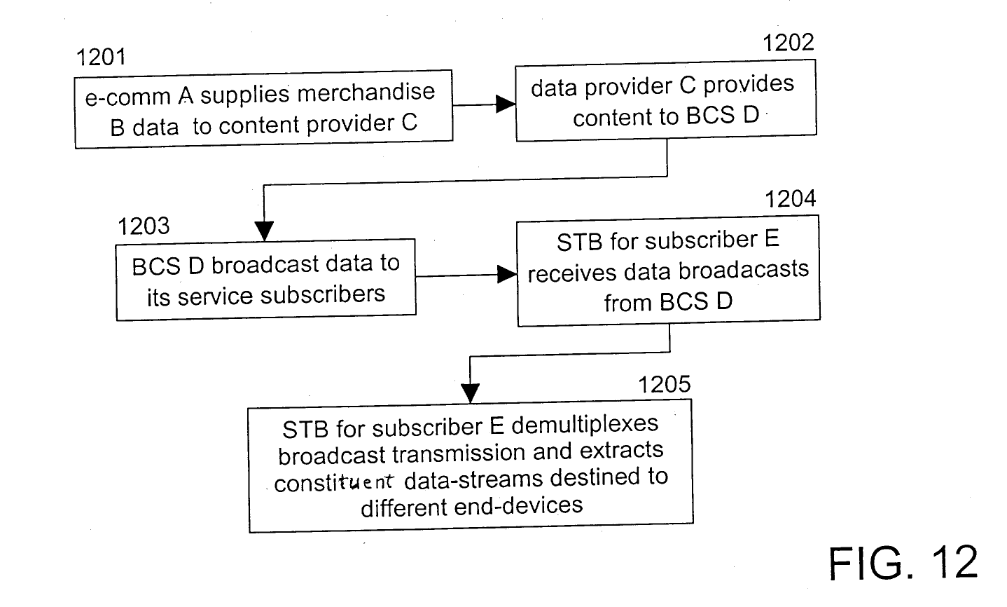

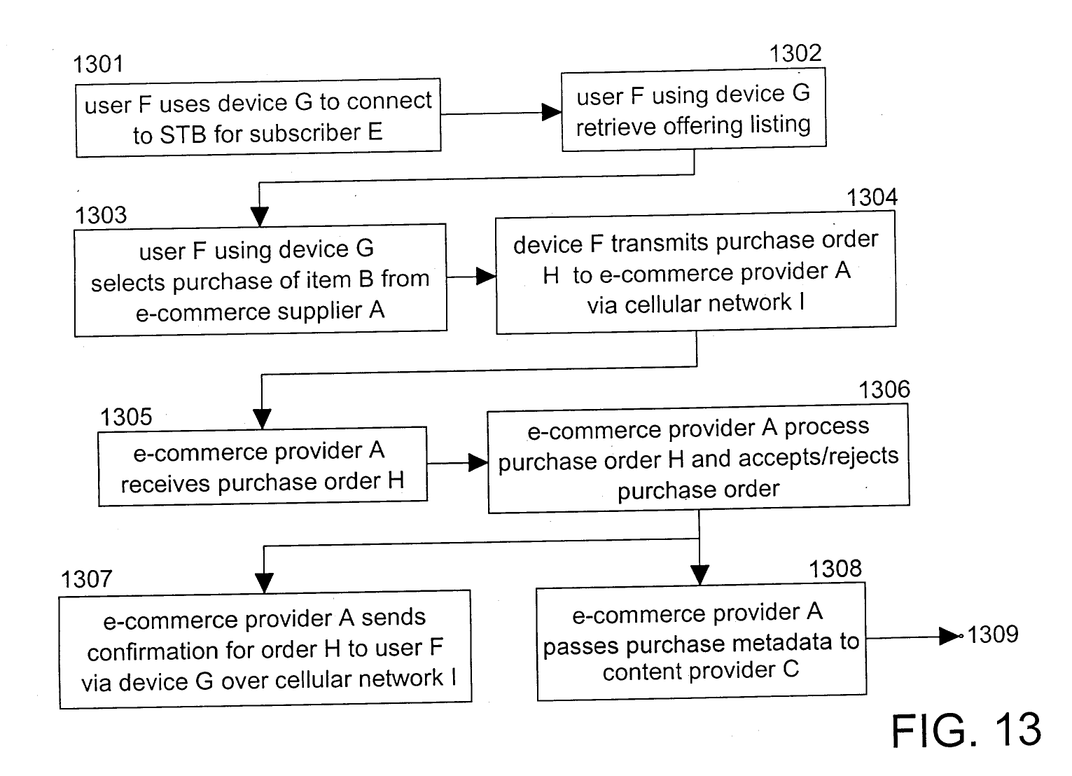

Again, using the exemplary embodiment in FIG. 6 as a basis, FIG. 12 and FIG. 13 show steps taken during an execution of the method of the invention. All possible steps are not shown in these figures. Further, not all steps shown are necessarily executed every time.

Similar steps can be used with any other of the exemplary embodiments in FIGS. 3 through 7 as well as any additional embodiments that those skilled in the art may create. FIG. 12 focuses on the dissemination of digital content via the one-way digital video broadcast distribution network. FIG. 13 focuses on the interaction between a user and a e-commerce service provider over a two-way (cellular) network. The letters used in these figures represent exemplary identifiers for the tagging processing shown in FIG. 10 and FIG. 11.

Prior to a broadcast transmission, FIG. 12 shows that in an exemplary first step 1201, e-commerce service provider A, e.g., an on-line apparel store, supplies to the digital content provider C information that describes its merchandise, and in particular merchandise B, e.g., a picture, size and color selection, type, price, etc., for a particular pair of shoes. The content provider C aggregates any content that it has received, see FIG. 6, and it passes the aggregate content to the broadcast content service D 1202. The broadcast data service D then broadcasts the content to its subscribers 1203. The set-top box for subscriber E receives the data broadcast from the broadcast content provider D 1204. The set-top box demultiplexes the received data transmission and avails the constituent data streams to any end-user devices capable of receiving them 1205. FIG. 12 shows a content provider being distinct from the broadcast service provider. This is one possible logical separation of functions. A content provider could physically be the same organization that also provides the content broadcast.

To retrieve any of the additional data streams in a data broadcast via the set-top box, FIG. 13 shows a first exemplary step 1301 where the user F using the personal device G first connects to the set-top box of subscriber E. As mentioned earlier the act of connecting can be done over several means, including a serial cable, a Bluetooth personal area network, a wireless local area network, etc. Following the connection, the user F, using the device G, retrieves a listing of available offerings 1302. This listing may be provided in the form of a Web page or any other form. In any case, in order to display the listing, a browser application, e.g., a Web browser, is required on the device G. The browser application matches a corresponding server application, e.g., a Web server, that resides in the set-top box that formats the additional data received over the broadcast network in a manner compatible to the browsing application. It possible (and thus not excluded) that the additional data can be broadcasted in a form that is already compatible with the browsing application, thus reducing substantially the amount of extra processing that the set-top box must do upon receiving the data.

After viewing the offering listing on device G, user F selects an item from the list, e.g., selects to purchase merchandise B from e-commerce service A 1303. The device G, which is capable of communications over the cellular network (see FIG. 6) transmits the purchase order H to the e-commerce provider A via the cellular network I 1304. The purchase order H can be identified by a set of identifiers, including the user name, his/her ID, his/her password, his/her credit card number, the subscriber ID E, etc. This set of identifiers can be used not only to execute the purchase transaction properly with the user F, but also to complete any billing, advertisement, payment, etc., responsibilities that the e-commerce provider may have to the content provider and/or the broadcast content service, as discussed below.

Following the transmission of the purchase order H to the e-commerce provider A, provider A receives the order 1305. It then process the order, e.g., verifies the credit card number, checks inventory, etc., and accepts or rejects the purchase order 1306. Subsequently, provider A provides the outcome of the processing of the purchase order H to user F and his/her device G by again using the cellular network I 1307. While returning the outcome of the purchase transaction over the digital broadcast network is possible and not excluded, it becomes much more difficult to manage the broadcast streams, and thus this embodiment considers the use of the cellular network as a return path from the e-commerce provider. As discussed earlier, the provider may pass information related to this e-commerce transaction (e.g., just the cost of the transaction, and perhaps no other information) to the content provider C 1308. The content provide may use this information to charge the e-commerce provider, pass some of this information to another party 1309, e.g., the broadcast content provider, etc.

Variations described for the present invention can be realized in any combination desirable for each particular application. Thus particular limitations, and/or embodiment enhancements described herein, which may have particular advantages to the particular application need not be used for all applications. Also, it should be realized that not all limitations need be implemented in methods systems and/or apparatus including one or more concepts of the present invention.

It will be understood that in accordance with the preferred embodiments of the invention, the separating and storage of the information being broadcast with the program content is advantageously done automatically, without intervention by the program view or the end user, who is then free to select and consider the information, or a portion of the information, when it is being broadcast or at later time. However, some intervention by someone watching the program content, or by the end user at a time before the broadcast starts, is generally not excluded from the scope of the invention. For example, it is possible to provide so that a viewer may decide to start or stop the storage of information, or that certain classes of information may be selected for or excluded from storage by the user.

The present invention can be realized in hardware, software, or a combination of hardware and software. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments has been provided as an example and not as a limitation. The scope of the invention is defined by the appended claims.

Having thus described our invention, what we claim as new and desire to secure by Letters Patent is as follows:

1. A method comprising:
disseminating information in a broadcast stream in which broadcasting program content and said information are broadcast to end user equipment by a broadcasting system, by:
receiving said broadcast stream;
separating and at least temporarily storing said information; and
retrieving said information for consideration by at least one end user.

2. The method as recited in claim 1, wherein said broadcasting system is a television broadcasting system, and said storing is accomplished in a set top box.

3. The method as recited in, claim 1, wherein said broadcasting system is a television broadcasting system, and said storing is accomplished at least partially in at least one digital device linked to a set top box.

4. The method as recited in claim 3, further comprising linking said digital device to said set top box via a communications link.

5. The method as recited in claim 4, wherein said link is a wireless link.

6. The method as recited in claim 5, wherein said link is one of a radio frequency link and an infrared link.

7. The method as recited in claim 3, wherein said digital device is one of a wireless telephone and a personal digital assistant.

8. The method of claim 3, wherein said digital device is capable of communication using a communication infrastructure other than said broadcasting system.

9. The method as recited in claim 8, wherein the communications infrastructure comprises at least one digital network.

10. The method as recited in claim 9, wherein the at least one digital network comprises the Internet.

11. The method as recited in claim 1, further comprising conducting a transaction based on said information using a communications infrastructure other than said broadcasting system.

12. The method as recited in claim 1, further comprising providing a protocol for disseminating information and conducting a transaction, said protocol including identifiers selected from the group of the end user, a broadcast subscriber, a broadcast services provider, a broadcast content provider, a data source, merchandise information, and a transaction identifier.

13. The method as recited in claim 12, wherein the retrieving and conducting a transaction are accomplished at a time other than during said broadcasting.

14. The method as recited in claim 12, wherein the retrieving and conducting a transaction are accomplished during said broadcasting.

15. The method as recited in claim 1, wherein different portions of said information are retrieved for different end users.

16. The method as recited in claim 1, wherein at least one end user receives commercial information.

17. The method as recited in claim 16, further comprising conducting a transaction based on said commercial information.

18. The method as recited in claim 17, wherein the transaction is conducted using a communications infrastructure other than said broadcasting system.

19. The method as recited in claim 1, wherein at least one end user receives commercial information and at least one other end user receives general information.

20. The method as recited in claim 19, wherein the general information is other than commercial information.

21. The method as recited in claim 19, wherein the general information comprises sports information.

22. The method as recited in claim 1, wherein the end user equipment comprises at least one of a television set top box, a personal digital assistant and a wireless telephone.

23. A system for utilizing information in a broadcast stream in which broadcasting program content and said information are broadcast to end user equipment by a broadcasting system, comprising:
first apparatus for receiving said broadcast stream, said apparatus separating and at least temporarily storing said information; and
second apparatus for retrieving at least a portion of said information.

24. The system as recited in claim 23, in combination with a broadcasting system.

25. The system as recited in claim 24, wherein said broadcasting system is a television broadcasting system, and said second apparatus includes a set top box.

26. The system as recited in claim 23, wherein said broadcasting system is a television broadcasting system, and said second apparatus includes a set top box and at least one digital device linked to said set top box.

27. The system as recited in claim 26, wherein said at least one digital device has a storage for said information.

28. The system as recited in claim 26, further comprising a communication link for linking said digital device to said set top box.

29. The system as recited in claim 28, wherein said link is a wireless link.

30. The system as recited in claim 29, wherein said link is one of a radio frequency link and an infrared link.

31. The system as recited in claim 30, wherein said digital device is one of a wireless telephone and a personal digital assistant.

32. The system as recited in claim 26, wherin said digital device further comprises apparatus for communication using a communications system other than said broadcasting system.

33. The system as recited in claim 32, wherein the communications infrastructure comprises at least one digital network.

34. The system as recited in claim 33, wherein the at least one digital network comprises the Internet.

35. The system as recited in claim 23, wherein operations are conducted in accordance with a protocol for disseminating information and conducting a transaction, said protocol including identifiers selected from the group of the end user, a broadcast subscriber, a broadcast services provider, a broadcast content provider, a data source, merchandise information, and a transaction identifier.

36. The system as recited in claim 23, wherein said second apparatus includes connection apparatus for connecting to a communications infrastructure to retrieve information and conduct a transaction during said broadcasting.

37. The system as recited in claim 23, further comprising apparatus for conducting a transaction based on said information using a communications infrastructure other than said broadcasting system.

38. The system as recited in claim 23, wherein said second apparatus includes connection apparatus for connecting to a communications infrastructure to retrieve information and conduct a transaction at a time other than during said broadcasting.

39. The system as recited in claim 23, further comprising apparatus for retrieving different portions of said information different end users.

40. The system as recited in claim 23, wherein at least one end user receives commercial information.

41. The system as recited in claim 40, further comprising apparatus for conducting a transaction based on said commercial information.

42. The system as recited in claim 41, wherein the apparatus for conducting a transaction conducts said transaction using a communications infrastructure other than said broadcasting system.

43. The system as recited in claim 23, wherein at least one end user receives commercial information and at least one other end user receives general information.

44. The system as recited in claim 43, wherein the general information is other than commercial information.

45. The system as recited in claim 43, wherein the general information comprises sports information.

46. The system as recited in claim 23, wherein the end user equipment comprises at least one of a television set top box, a personal digital assistant and a wireless telephone.

47. An article of manufacture comprising a computer usable medium having computer readable program code means embodied therein for causing a first device which receives information in a broadcast stream in which broadcasting program content and said information are broadcast to an end user by a broadcasting system, said computer readable program code comprising:
code for processing digital data of said broadcast stream;
code for separating and at least temporarily storing said information; and
code for facilitating transfer of said information to a second device.

48. The article of manufacture as recited in claim 47, wherein said broadcasting system is a television broadcasting system, and said article of manufacture is disposed in a set top box.

49. The article of manufacture as recited in claim 48, in combination with an additional article of manufacture for storing additional computer readable program code, said additional article of manufacture being disposed in a digital device linked to said set top box, said additional article of manufacture having code for facilitating storage of said information in said digital device.

50. The article of manufacture as recited in claim 49, further comprising code for linking said digital device to said set top box via a communications link.

51. The article of manufacture as recited in claim 49, in combination with said additional article of manufacture for storing additional computer readable program code, said additional computer readable code facilitating communication of said digital device via at least one digital network.

52. The article of manufacture as recited in claim 51, wherein the at least one digital network comprises the Internet.

53. The article of manufacture as recited in claim 47, further comprising additional computer readable program code for conducting a transaction based on said information using a communications infrastructure other than said broadcasting system.

54. The article of manufacture as recited in claim 47, further comprising additional computer readable program code for facilitating a transaction during said broadcasting.

55. The article of manufacture as recited in claim 29, further comprising additional computer readable program code for facilitating a transaction at a time other than during said broadcasting.

56. The article of manufacture as recited in claim 47, further comprising code for defining a protocol for disseminating information and conducting a transaction, said protocol including identifiers selected from the group of the end user, a broadcast subscriber, a broadcast services provider, a broadcast content provider, a data source, merchandise information, and a transaction identifier.

57. The article of manufacture as recited in claim 47, further comprising additional code for retrieving different portions of said information for different end users.

58. The article of manufacture as recited in claim 47, wherein said additional code retrieves commercial information for at least one end user.

59. The article of manufacture as recited in claim 58, further comprising additional code for conducting a transaction based on said commercial information.

60. The article of manufacture as recited in claim 59, wherein said additional code conducts the transaction using a communications infrastructure other than said broadcasting system.

61. The article of manufacture as recited in claim 47, further comprising additional computer code for retrieving commercial information for at least one end user, and for retrieving general information at least one other end user.

62. The article of manufacture as recited in claim 61, wherein the general information is other than commercial information.

63. The article of manufacture as recited in claim 62, wherein the general information comprises sports information.

64. The article of manufacture as recited in claim 1, wherein the end user equipment comprises at least one of a television set top box, a personal digital assistant and a wireless telephone.

65. A program storage device readable by machine, tangibly embodying a program of instructions executable by the machine to perform method steps for conducting a transaction, said method steps comprising:
receiving information that was carried in a broadcast stream;
storing at least a portion of said information;
retrieving at least a portion of the information stored; and
conducting a transaction based on information that is retrieved.

66. The program storage device as recited in claim 65, wherein the program permits the transaction to be conducted during the broadcast, or at a time after the broadcast.

67. The program storage device as recited in claim 65, wherein said method steps further comprise receiving said information from a device that separates said information from other broadcast content.

68. An apparatus comprising:
means for disseminating information in a broadcast stream in which broadcasting program content and said information are broadcast to end user equipment by a broadcasting means, including:
means for receiving said broadcast stream:
means for separating and at least temporarily storing said information: and
means for retrieving said information for consideration by at least one end user.

69. The apparatus as recited in claim 68, wherein said means for separating and at least temporarily storing said information operates automatically.
